(19) United States
(12) Patent Application Publication
(10) Pub. No.: US 2022/0404159 A1
(43) Pub. Date: Dec. 22, 2022

(54) MASS TRANSPORTATION RIDERSHIP DATA IMPORT

(71) Applicant: EDUCATION LOGISTIC, INC., Missoula, MT (US)

(72) Inventor: Hien Nguyen, Missoula, MT (US)

(21) Appl. No.: 17/711,920

(22) Filed: Apr. 1, 2022

Related U.S. Application Data
(60) Provisional application No. 63/169,765, filed on Apr. 1, 2021.

(51) Int. Cl. G01C 21/34; G01C 21/00

(52) U.S. Cl. CPC G01C 21/3438; G01C 21/3804

(57) ABSTRACT

At least one computer-readable medium on which are stored instructions that, when executed by one or more processing devices, enable the one or more processing devices to perform a method. The method includes the steps of receiving over a network a data set corresponding to a passenger seeking transportation to a destination, the data set including an address of origin of the passenger, accessing a first database that includes a first set of geocodes that correspond to addresses within a particular geographic region of interest, the region of interest including the passenger address of origin, determining if there is a geocode in the first database that corresponds to the passenger address of origin, if there is not a geocode in the database that corresponds to the passenger address of origin, automatically creating a geocode that corresponds to the passenger address of origin, and providing the created geocode to a route management system.

### PRIORITY CLAIM

This application claims priority to U.S. Provisional Patent Application Ser. No. 63/169,765 filed Apr. 1, 2021, which is hereby incorporated by reference in its entirety as if fully set forth herein.

### BACKGROUND

Current import processes in the industry are limited to light integration between source systems (usually a student information system) and a route management system (RMS). Often, this takes the form of a shared comma-separated value (CSV) file. Integration efforts will confirm that the CSV format is acceptable for input, but that is it. Validation of the data itself does not happen, and this is how inaccurate student transportation data is imported into the route management system. In this sense, validation is not a need that has been addressed by previous approaches taken in this field.

Validation of student data for the purposes of transportation has not been a need that has been explicitly addressed by existing import processes. The mistaken assumption is that student information in non-transportation systems is adequate for transportation purposes. However, that is often not the case, and some validation and processing is required before the data is ready.

To summarize, current tools and approaches do not recognize data validation as a need that must be addressed.

### BRIEF DESCRIPTION OF THE DRAWINGS

FIG. 1 is a schematic view of an exemplary operating environment in which an embodiment of the invention can be implemented;

FIG. 2 is a functional block diagram of an exemplary operating environment in which an embodiment of the invention can be implemented;

FIGS. 3-7C are flowcharts illustrating processes according to one or more embodiments of the invention;

FIGS. 8-10 illustrate user interfaces according to one or more embodiments of the invention; and

FIGS. 11-19 illustrate the functionality of a location picker according to an embodiment of the invention.

### DETAILED DESCRIPTION

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the invention may be described in the general context of computer-executable instructions, such as program modules, being executed by a processing device having specialized functionality and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

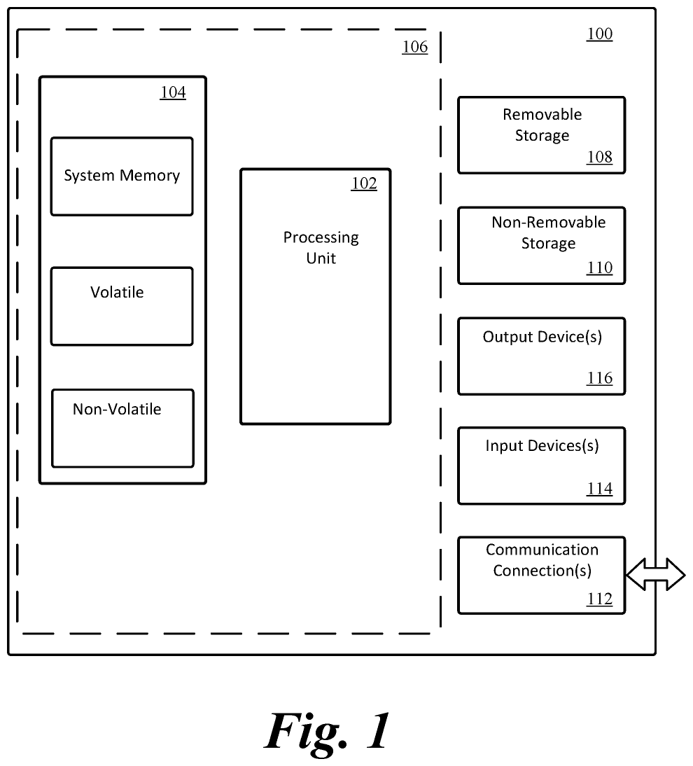

With reference to FIG. 1, an exemplary system for implementing an embodiment of the invention includes a computing device, such as computing device 100, which, in an embodiment, is or includes a smartphone. The computing device 100 typically includes at least one processing unit 102 and memory 104.

Depending on the exact configuration and type of computing device, memory 104 may be volatile (such as random-access memory (RAM)), nonvolatile (such as read-only memory (ROM), flash memory, etc.) or some combination of the two. This most basic configuration is illustrated in FIG. 1 by dashed line 106.

Additionally, the device 100 may have additional features, aspects, and functionality. For example, the device 100 may include additional storage (removable and/or non-removable) which may take the form of, but is not limited to, magnetic or optical disks or tapes. Such additional storage is illustrated in FIG. 1 by removable storage 108 and non-removable storage 110. Computer storage media includes volatile and nonvolatile, removable and non-removable media implemented in any method or technology for storage of information such as computer-readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 100. Any such computer storage media may be part of device 100.

The device 100 may also include a communications connection 112 that allows the device to communicate with other devices. The communications connection 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, the communication media includes wired media such as a wired network or direct-wired connection, and wireless media such as acoustic, radio-frequency (RF), infrared, cellular and other wireless media. The term computer-readable media as used herein includes both storage media and communication media.

The device 100 may also have an input device 114 such as keyboard, mouse, pen, voice-input device, touch-input device, etc. Further, an output device 116 such as a display, speakers, printer, etc. may also be included. Additional input devices 114 and output devices 116 may be included depending on a desired functionality of the device 100.

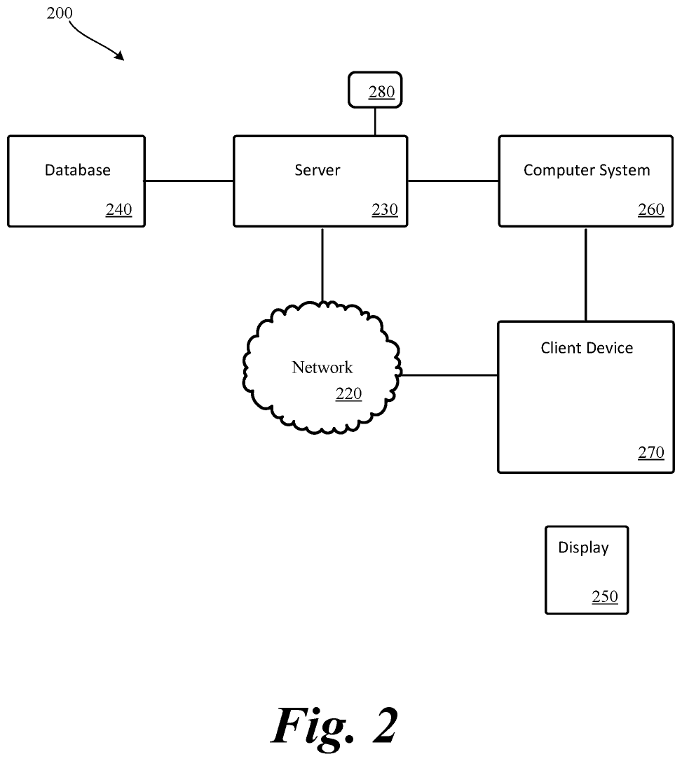

Referring now to FIG. 2, an embodiment of the present invention may take the form, and/or may be implemented using one or more elements, of an exemplary computer network system 200 that, in an embodiment, includes a server 230, database 240 and computer system 260. The system 200 may communicate with an electronic client device 270 that is linked via a communication medium, such as a network 220 (e.g., the Internet), to one or more electronic devices or systems, such as server 230. The server 230 may further be coupled, or otherwise have access, to a database 240 and a computer system 260. Although the embodiment illustrated in FIG. 2 includes one server 230 coupled to one client device 270 via the network 220, it should be recognized that embodiments of the invention may be implemented using one or more such client devices coupled to one or more such servers.

The client device 270 and the server 230 may include all or fewer than all of the features associated with the device 100 illustrated in and discussed with reference to FIG. 1. The client device 270 includes or is otherwise coupled to a computer screen or display 250. The client device 270 may be used for various purposes such as network- and local-computing processes.

The client device 270 is linked via the network 220 to server 230 so that computer programs, such as, for example, a short message service (SMS) application, running on the client device 270 can cooperate in two-way communication with server 230. The server 230 may be coupled to database 240 to retrieve information therefrom and to store information thereto. Database 240 may have stored therein data (not shown) that can be used by the server 230 and/or client device 270 to enable performance of various aspects of embodiments of the invention. The data stored in database 240 may include, for example, a set of geocodes that correspond to addresses within a particular geographic region of interest. Additionally, the server 230 may be coupled to the computer system 260 in a manner allowing the server to delegate certain processing functions to the computer system. In an embodiment, most or all of the functionality described herein may be implemented in a desktop or smartphone application that may include one or more executable modules. In an embodiment, the client device 270 may bypass network 220 and communicate directly with computer system 260.

An embodiment of the invention provides a utility that manages the import of student data into a route management system 280 that may be administered/executed by server 230 and/or computer system 260. Such a utility manages the processing and parsing of student data before it is imported into the route management system. An embodiment streamlines the import of student data into a route management system, and to ensure that accurate information is imported before routes are built and transportation is assigned.

The purpose of a route management system is to allow users to design and develop bus routes that meet their students' transportation needs. In other words, the problem that a router needs to solve with the route management system is almost entirely defined by the students that are imported and loaded in the system. Inaccurate student information leads to ineffective routes.

The import of students straddles a grey area of responsibility between the source system (often a student information system) and the route management system, which means that the import of students into the route management system is rarely an area of focus, and is a common source of problems for routers.

Inaccurate student data, from poor import processes and utilities, is a common pain point for school bus routers. While routers should be spending most of their time building routes, they find that they are spending an unexpected amount of time simply getting student data into the route management system. A routing management system that works with an embodiment would be attractive to most school bus routers.

An embodiment may be broken down into three phases: Preformatting, Upload and validation, and Import and quick assign.

Preformatting

A goal of the preformatting task aggregates and converts data from external systems into a format that is consumable by an embodiment.

The most basic activity is taking external data and converting it to a compatible format. This involves formatting data, renaming fields, and reorganizing data. This activity is supported by many other routing vendors.

The unique contribution of an embodiment to the preformatting step is the ability to create derived fields. This goes beyond simple reorganization of the data and can combine and process input fields to derive new fields. Examples of this include the use of home address, school, grade, and program to determine transportation eligibility, whether home stops are required, whether right-hand-side pickups are required, etc.

The initial preformatting stage may be performed by an expert in an embodiment. If the client does not have one available, a consultant can be provided. The work of this expert can be repackaged as a standalone executable and can be used for future preformatting tasks without requiring the help of an expert.

Upload and Validation

The preformatted data can be uploaded into a UI for review. The user can review the student's information, including name, date of birth, address, school, grade, and program.

Review of the address, school, grade, and program is advantageous at this point. Correction of any problems in the data allow downstream software, i.e., routing software, to be much more effective. One contribution of an embodiment is allowing the user to review this data before finally importing it into the routing system.

An embodiment allows the user to review uploaded files and to drill down into the details of each. For each uploaded file, the user can identify which students have valid/invalid information, which students have been imported, which students are waiting to be imported, and which students require additional data work.

The tools available for reviewing and validating a student's address are particularly rich. The student's address, whether from the upload or entered by the user, is validated against the routing system's map (geocode). The presence of the address in the geocode is important and a goal of validation; if the address is in the geocode, an embodiment can route to it. The initial step in validation checks for the presence of the address in the geocode. If it is there, then address validation is complete and the user can move on to the validation of other fields.

If the address is not present, then an embodiment will attempt to automatically create the address in the geocode, either from using the geocode itself or use of an external geocode, such as Google Maps. Whether or not the address can be created automatically depends on a number of factors, including address format (many addresses are formatted incorrectly), proximity to the existing geocode, and of course whether or not the address actually exists.

If address creation fails, then the user can use a Location Picker feature (described in greater detail below) to create and validate the new address. In Location Picker, the user is walked through the process of validating the address, because the most common reason for address validation and creation failure is an improper address. Address validation can be done against the routing geocode or against external geocodes, such as Google Maps. If address validation fails, the user can select a location on the map and force the creation of a location.

Validation of school, grade, and program happens against the routing data, that would have been previously set up. Validation of school, grade, and program is an advantageous step because this allows for the categorization of students by belltime, which is a new and central organizational model in an embodiment.

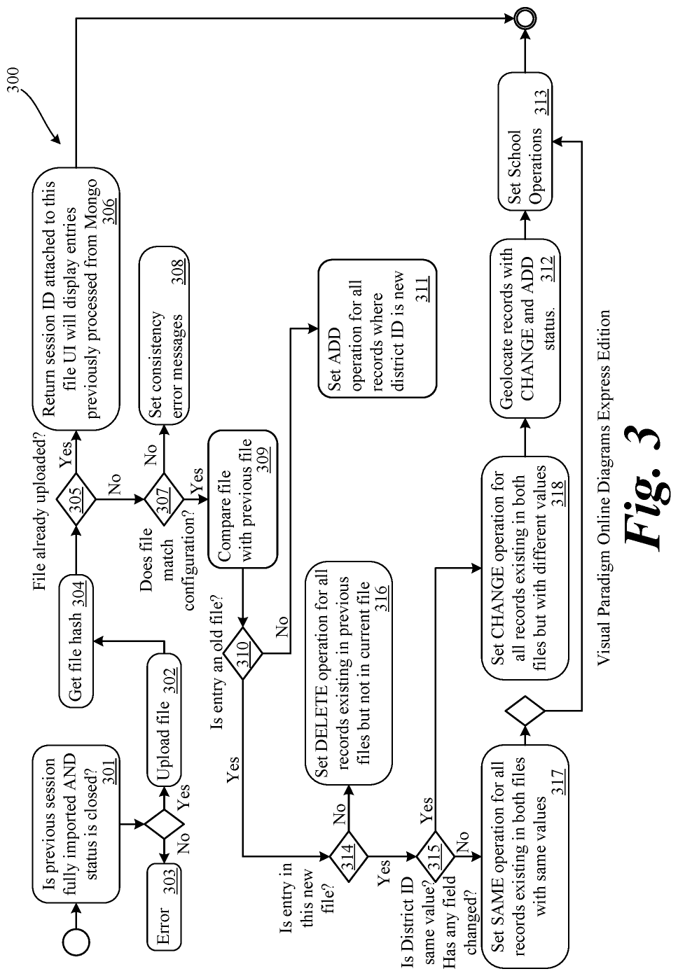

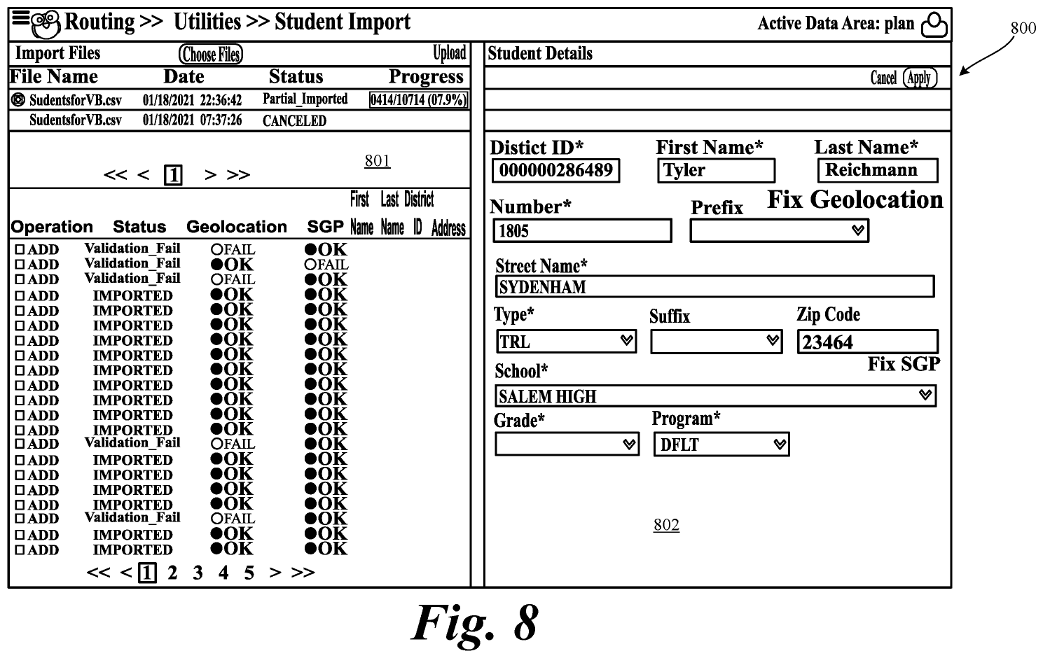

FIG. 3 illustrates a process 300, according to an embodiment of the invention, for uploading one or more CSV files containing students' entries so that such entries are appearing in the left data panel 801 and right data panel 802 of the UI 800 illustrated in FIG. 8 to achieve the objectives of the invention discussed above herein. The process 300 is illustrated as a set of operations shown as discrete blocks. One or more steps of the process 300 may be implemented in any suitable hardware, software, including instructions embodied within components, firmware, or combination thereof and enabled by data calls to database 240 from one or more of client device 270, server 230 and computer system 260. The order in which the operations associated with the process 300 are described is not to be necessarily construed as a limitation.

At a step 301, a determination is made as to whether a previous session has been fully imported and status is closed. If the determination is negative, then an error message is generated at a step 303. If the determination is positive, then a CSV file is uploaded at a step 302 and a hash value corresponding to the file is retrieved at a step 304.

At a step 305, a determination is made as to whether the file in question has already been uploaded. If the file has already been uploaded, then the UI 800 will display file entries previously processed from database 240 and the process 300 ends.

If the file has not already been uploaded, then, at a step 307, a determination is made as to whether the file in question matches a predetermined configuration. If the file does not match the predetermined configuration, then, at a step 308, at least one consistency error message is generated. If the file does match the predetermined configuration, then the file is compared with previously updated files at a step 309.

At a step 310, a determination is made as to whether the student entry is in a previously uploaded file. If not, an ADD operation is set for all records where districtID is new, records are geolocated with CHANGE and ADD status, and school operations are set at steps 311, 312 and 313, and process 300 ends.

If the student entry is in a previously uploaded file, a determination is made as to whether the student entry is in the new file to be uploaded at a step 314. If not, then a DELETE operation is set for all records existing in previously uploaded files except the file in question at a step 316. If so, then a determination is made as to whether any fields in the student entry have changed at a step 315.

If no fields have changed, the a SAME operation is set for all records existing in both files with same values at a step 317 and school operations are set at step 313. If any fields have changed, a CHANGE operation is set for all records existing in both files but with different values at a step 318. Subsequently, records are geolocated with CHANGE and ADD status, and school operations are set at steps 312 and 313, and process 300 ends.

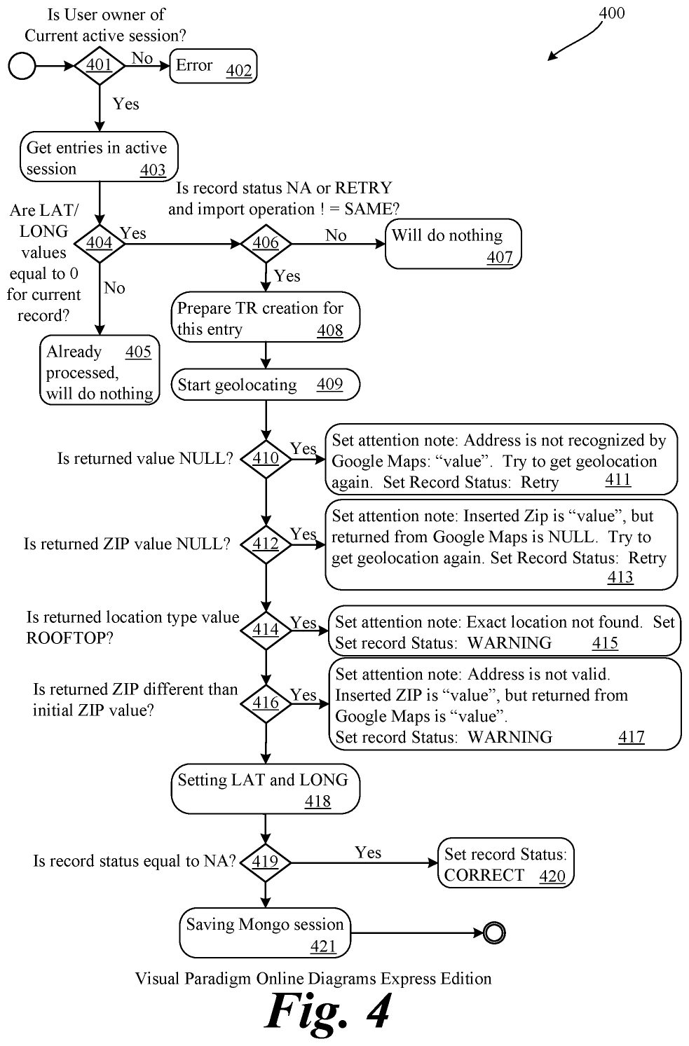

FIG. 4 illustrates a process 400, according to an embodiment of the invention, for performing an automated check on information for any student listed in the left data panel 801 of the UI 800 illustrated in FIG. 8 so that their eligibility for inclusion in a particular route can be determined to achieve the objectives of the invention discussed above herein. The process 400 is illustrated as a set of operations shown as discrete blocks. One or more steps of the process 400 may be implemented in any suitable hardware, software, including instructions embodied within components, firmware, or combination thereof and enabled by data calls to database 240 from one or more of client device 270, server 230 and computer system 260. The order in which the operations associated with the process 400 are described is not to be necessarily construed as a limitation.

At a step 401, a determination is made as to whether the user is the owner of the current active session. If the determination is negative, then an error message is generated at a step 402. If the determination is positive, then student entries to be checked are placed in the active session at a step 403.

At a step 404, a determination is made as to whether latitude/longitude values are equal to 0 for a record entry in question. If the determination is negative, then the record entry is indicated at a step 405 as having been already processed, and no further processing is performed with respect to that entry. If the determination is positive, then a determination is made at a step 406 as to whether the status of the record is NA (i.e., not applicable, still not processed), CORRECT, or RETRY when import operation is not set to SAME.

If the determination at 406 is negative, then at a step 407 no further action is taken with respect to the entry. If such determination is positive, then a transportation request (TR) record is created for the entry in question at a step 408.

At a step 409, a geolocation operation is begun for the entry. At a step 410, a determination is made as to whether the returned value is NULL. If such determination is positive, then, at a step 411, the address is not recognized by the mapping application (e.g., Google Maps®), the record status is set to RETRY, and a further geolocation attempt is performed. If the determination is negative then, at a step 412, a determination is made as to whether the returned zip code value is NULL. If such determination is positive, then, at a step 413, the record status is set to RETRY, and a further geolocation attempt is performed. If the determination is negative then, at a step 414, a determination is made as to whether the returned location type value is ROOFTOP. If such determination is positive, then, at a step 415, the record status is set to WARNING as the exact location was not found. If the determination is negative then, at a step 416, a determination is made as to whether the returned zip code value is different from the initial zip code value. If such determination is positive, then, at a step 417, the record status is set to WARNING, as the address in not valid. If the determination is negative then, at a step 418, the latitude/longitude are set.

At a step 419, a determination is made as to whether status of the record is equal to NA. If such determination is positive, then at a step 420, the record status is set to CORRECT. Otherwise and/or in addition, the session is saved to database 240 at a step 421.

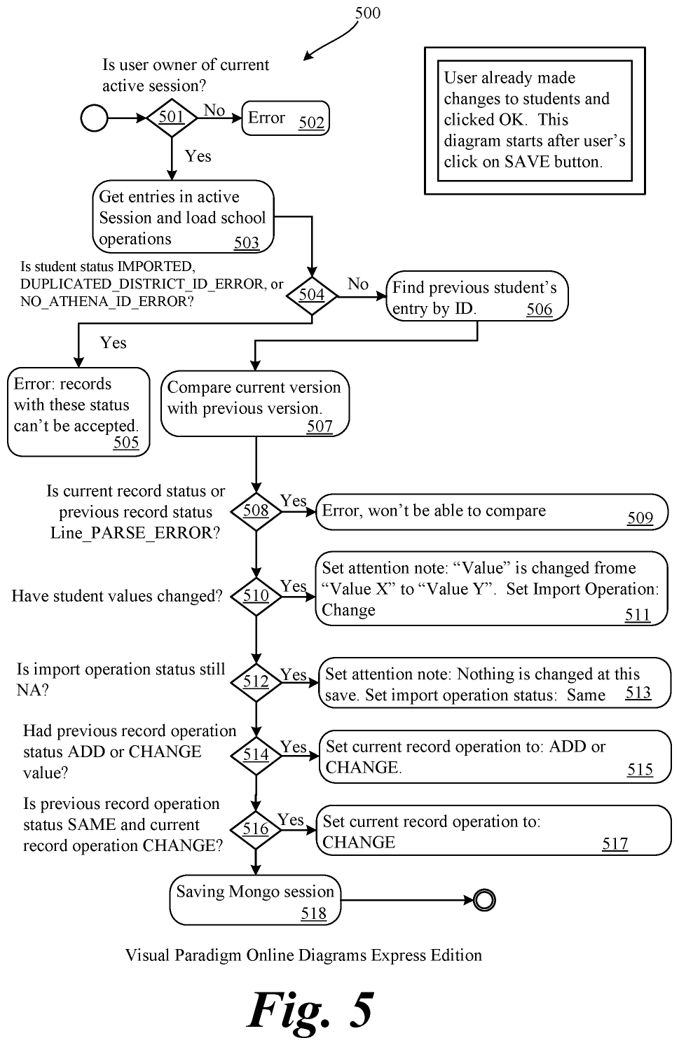

FIG. 5 illustrates a process 500, according to an embodiment of the invention, for editing student record entries listed in the left data panel 801 of the UI 800 illustrated in FIG. 8 to ensure correct information and to achieve the objectives of the invention discussed above herein. The process 500 is illustrated as a set of operations shown as discrete blocks. One or more steps of the process 500 may be implemented in any suitable hardware, software, including instructions embodied within components, firmware, or combination thereof and enabled by data calls to database 240 from one or more of client device 270, server 230 and computer system 260. The order in which the operations associated with the process 500 are described is not to be necessarily construed as a limitation.

At a step 501, a determination is made as to whether the user is the owner of the current active session. If the determination is negative, then an error message is generated at a step 502. If the determination is positive, then student entries to be edited are placed in the active session and school operations are loaded at a step 503.

At a step 504, a determination is made as to whether the status of the student entry is already imported or otherwise includes an error. If affirmative, then a notification is generated at a step 505 that such an entry cannot be accepted and edited. Otherwise, at a step 506, the student's prior entry is located using an associated identification number.

At a step 507, the current version of the student's entry is compared with the previous version. At a step 508, a determination is made as to whether the current or previous record status includes an error. If affirmative, then a notification is generated at a step 509 that a comparison of the entries cannot be made. Otherwise, at a step 510, a determination is made as to whether values in the previous record have or are being changed. If affirmative, then, at a step 511, the import operation is set to CHANGE. If negative, then, at a step 512, a determination is made as to whether the import operation status remains NA. If affirmative, then, at a step 513, the import operation is set to SAME. If negative, then, at a step 514, a determination is made as to whether the previous record operation status had and ADD or a CHANGE value. If affirmative, then, at a step 515, the current record operation is set to ADD or a CHANGE. Otherwise, at a step 516, a determination is made as whether the previous record operation has a SAME status and the current record operation has a CHANGE status. If affirmative, then, at a step 517, the current record operation is set to CHANGE. Otherwise and/or in addition, the session is saved to database 240 at a step 518.

Import and QuickAssign

Generally, the user can import all students with validated information and QuickAssign them. QuickAssign will, for each student record, locate a compatible nearby stop and assign them to that stop. If the routing system is sufficiently set up (i.e., there are runs and routes already created), then the student can be automatically assigned complete transportation. Transportation is complete when a student has transportation which gets him from home to school and from school to home.

Validation of student data can be a time-consuming task. In cases where the benefits of validating and correcting data do not outweigh the costs of delays, the user can force the system to import student records that have not been yet validated.

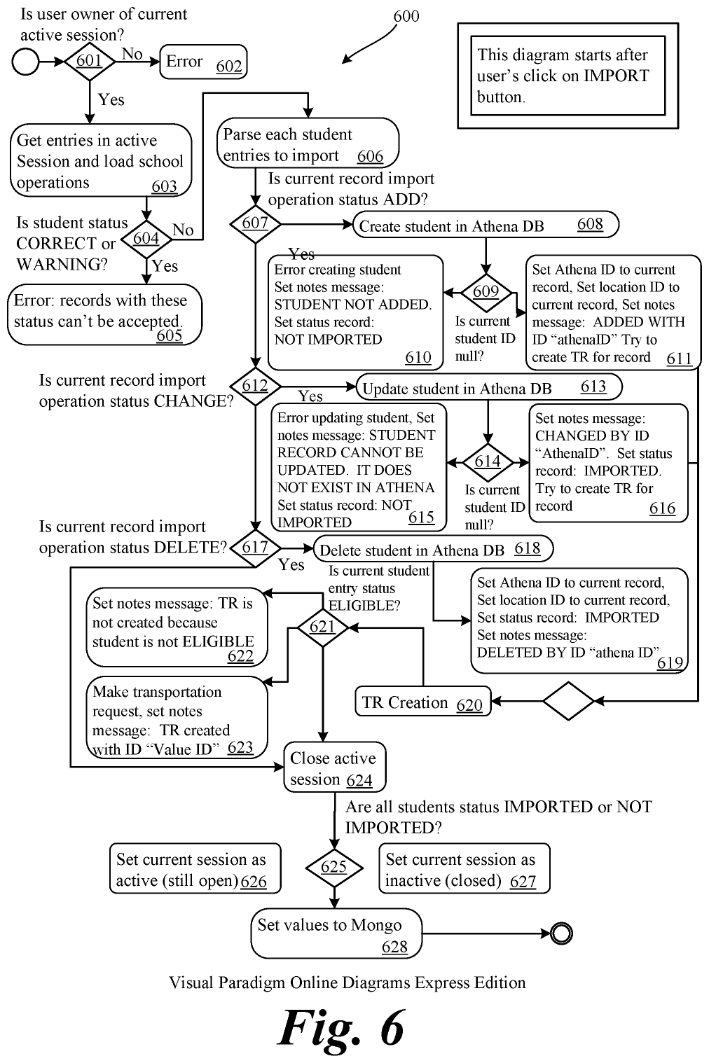

FIG. 6 illustrates a process 600, according to an embodiment of the invention, for importing/persisting all student record entries listed in the left data panel 801 of the UI 800 illustrated in FIG. 8 to ensure their availability to the route management system to achieve the objectives of the invention discussed above herein. The process 600 is illustrated as a set of operations shown as discrete blocks. One or more steps of the process 600 may be implemented in any suitable hardware, software, including instructions embodied within components, firmware, or combination thereof and enabled by data calls to database 240 from one or more of client device 270, server 230 and computer system 260. The order in which the operations associated with the process 600 are described is not to be necessarily construed as a limitation.

At a step 601, a determination is made as to whether the user is the owner of the current active session. If the determination is negative, then an error message is generated at a step 602. If the determination is positive, then student entries to be imported are placed in the active session and school operations are loaded at a step 603.

At a step 604, a determination is made as to whether the status of the student entry is CORRECT or WARNING. If affirmative, then a notification is generated at a step 605 that such an entry cannot be accepted and imported. Otherwise, at a step 606, each of the student entries is parsed for importation.

At a step 607, a determination is made as to whether the current record import operation status is set to ADD. If negative, the process 600 proceeds to a step 612. Otherwise, a student record is created in the database 240 at a step 608. At a step 609, a determination is made as to whether the current student ID is null. If negative, then the student entry will not be added and a message indicating that such is the case is generated at a step 610. Otherwise, an RMS ID and location ID are set to the current record, status of the current record is set to IMPORTED at a step 611 and creation of a TR for the record is attempted at a step 620. At a step 621, a determination is made as to whether the current student entry has a status of ELIGIBLE. If negative, then a message is generated at a step 622 that the TR is not created. Otherwise, the TR is created for the current student entry at a step 623. The process then proceeds to a step 624.

At a step 612, a determination is made as to whether the current record import operation status is set to CHANGE. If negative, the process 600 proceeds to a step 617. Otherwise, a student record is updated in the database 240 at a step 613. At a step 614, a determination is made as to whether the current student ID is null. If negative, then the student entry will not be updated and a message indicating that such is the case is generated at a step 615. Otherwise, the current record is indicated as CHANGED using an RMS ID, the status of the current record is set to IMPORTED at a step 616 and creation of a TR for the record is attempted at a step 620. At a step 621, a determination is made as to whether the current student entry has a status of ELIGIBLE. If negative, then a message is generated at a step 622 that the TR is not created. Otherwise, the TR is created for the current student entry at a step 623. The process then proceeds to a step 624.

At a step 617, a determination is made as to whether the current record import operation status is set to DELETE. If negative, the process 600 proceeds to a step 624. Otherwise, a student record is deleted from the database 240 at a step 618. At a step 619, the current record is indicated as DELETED, and the status of the current record is set to IMPORTED.

At a step 624, the active session is closed. At a step 625, a determination is made as to whether the status of all student entries are set to IMPORTED or NOT IMPORTED. If NOT IMPORTED, then the current session is set to active at a step 626. If IMPORTED, then the current session is maintained as inactive (closed) at a step 627. Subsequently, the status values are saved to database 240.

A contribution of an embodiment is including an interactive module that allows the user to review, correct, and validate data before it is saved into the route management system.

The most important data that the user can review and correct is the student address. Often, in the student information system, the mailing address is used, but a mailing address is not always for appropriate for transportation.

In addition to location data, the user can review and validate school, grade, program, and personal information as well, all of which are either necessary for route management or for integration with other products such as a parent application.

A Location Picker (LP) according to an embodiment is adapted to the new Geocode DB, Geocode Services and made consistent with the processes implemented in GeocodeEditor.

LP works as a modal window triggered in all modules of Athena when a location data entry (address, intersection, landmark, etc.) requires the intervention of the user. If a location data entry is successfully matched, Athena simply uses the matched location and bypasses LP.

In an embodiment, LP starts with a location input that cannot be matched by the RMS. Whenever address matching is executed in LP, it will follow the A-B-C order defined for the RMS tenant. An address matching is successful if there is a unique location returned from the matching process.

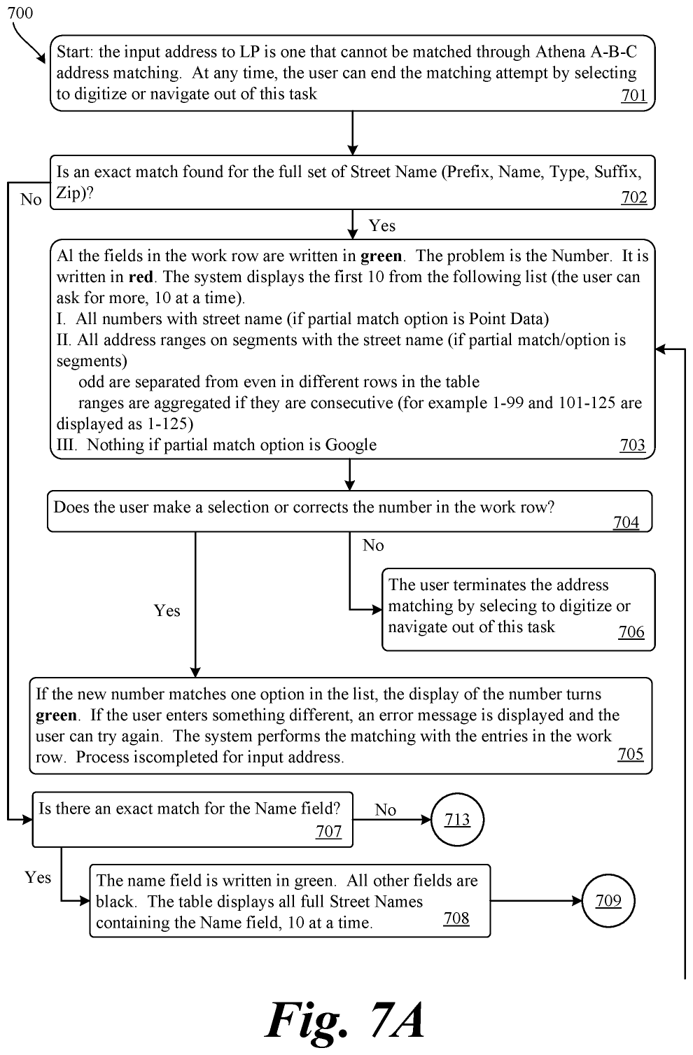

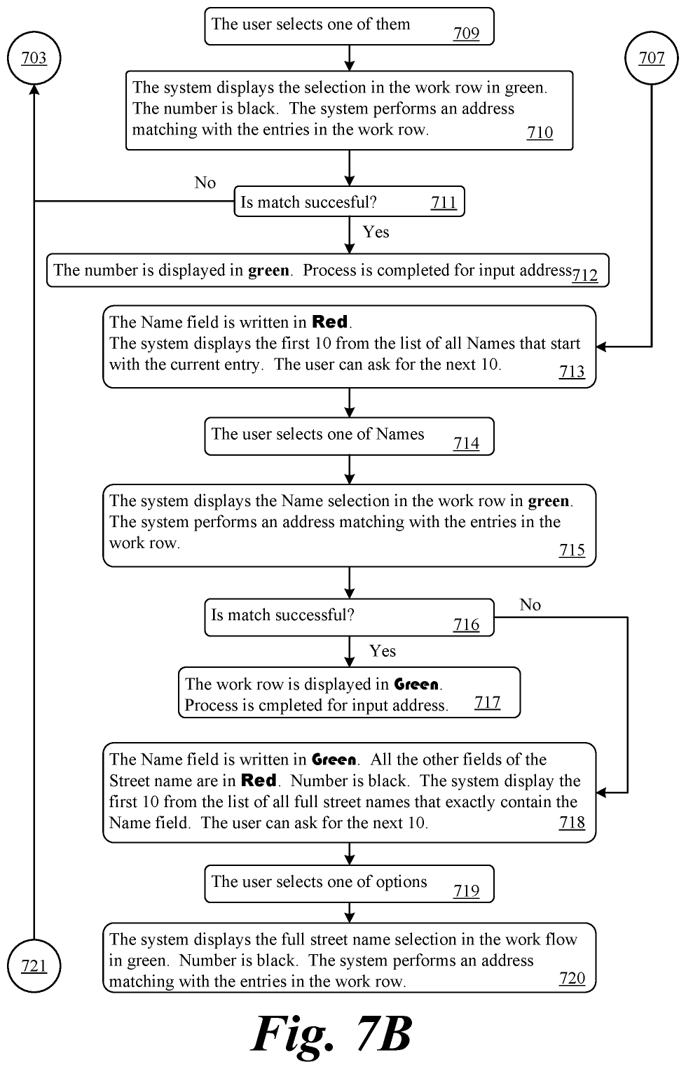

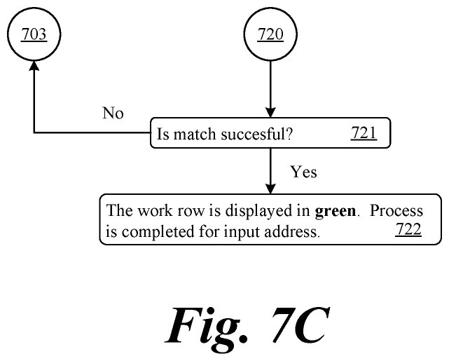

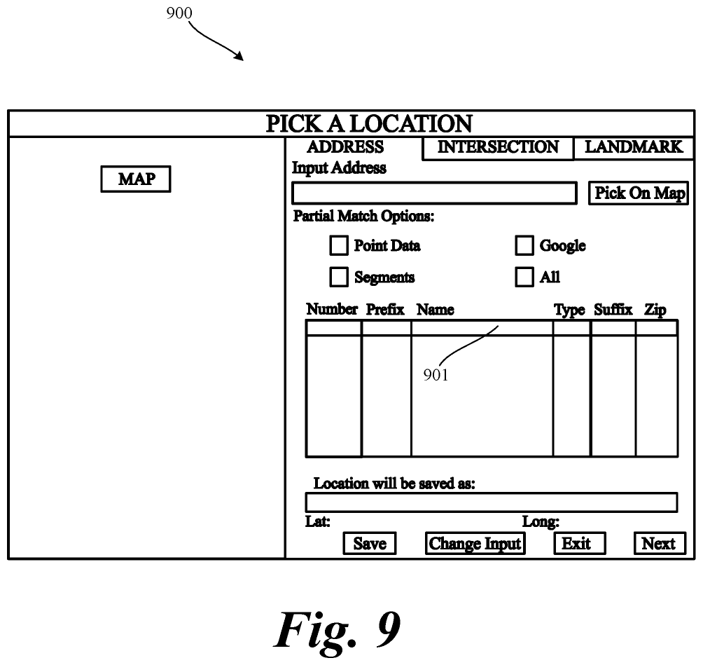

Referring to FIG. 9, LP is called by a module in Athena when an input address cannot be matched automatically. LP starts with that address shown as the input to the address matching attempt and initiate the process described with reference to FIGS. 7A-7C.

The work in LP is organized in successive sessions of address matching. Each session starts with an input address. A session is completed when the user has found the location needed, or starts a new session by entering a new input address (by possibly editing the old input address). Entering/modifying an input address may only possible by clicking on the button “Change Input”.

The input address is not editable (within the session working with that address). All work with correcting the address can be done in the work row 901 of the table (first row) or in the “Location will be saved as” field in the case of digitization.

LP offers partial matching to help the user solve the problem. When LP is started, the default option for partial matching attempt is to use Point Data. The user can select any option at will at any time.

After the address matching process is successfully completed, the final corrected address is displayed as an unparsed address for user's final confirmation.

The navigation buttons are:

Save: accept the result of the session with the location saved as indicated.

Change Input: allow the user to change the input address. After this is done, the rest of the window is cleared to start a new session.

Exit: close the window without saving.

Next: option available when applicable (LP is called to operate on a list of input entries), equivalent to a “Change Input” except this is automatic action.

At any time in LP, the user can select to disregard the address matching attempt and:

Click on the button “Pick on Map” to start the digitizing process. This is identical to what is done in GeocodeEditor when creating an address location point data by digitizing. At the final stage of confirming the digitization, the user is given an opportunity to correct the way the location is finally saved. The input address is written in the field “location will be saved as” and the user can edit that field; or

click on the button “Change Input”. The system places the cursor in the input address field and allows the user to type the new info. A new session is started with this new input (the previous session is cleared).

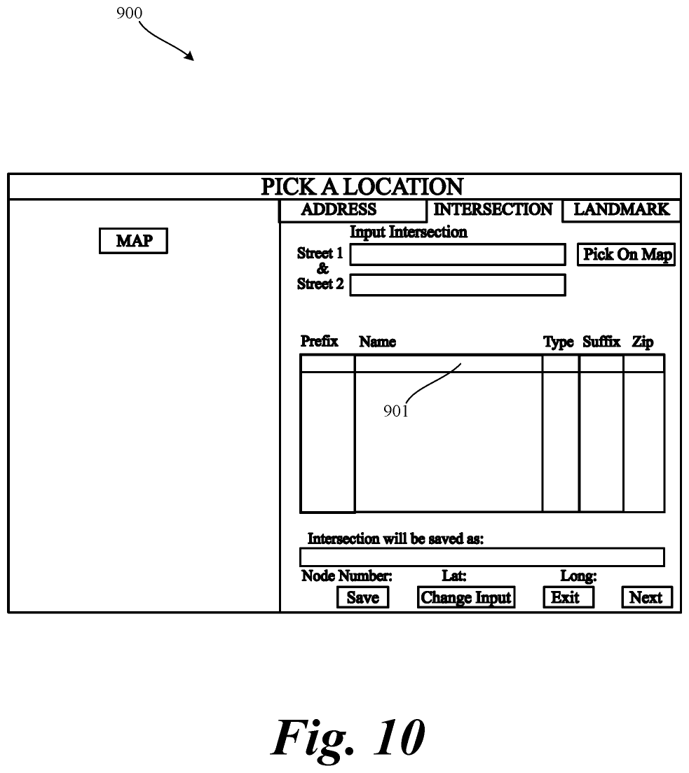

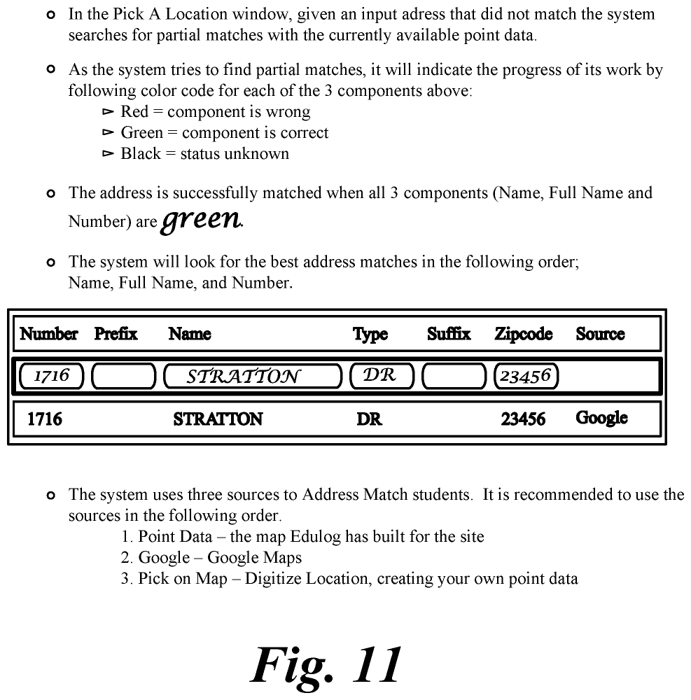

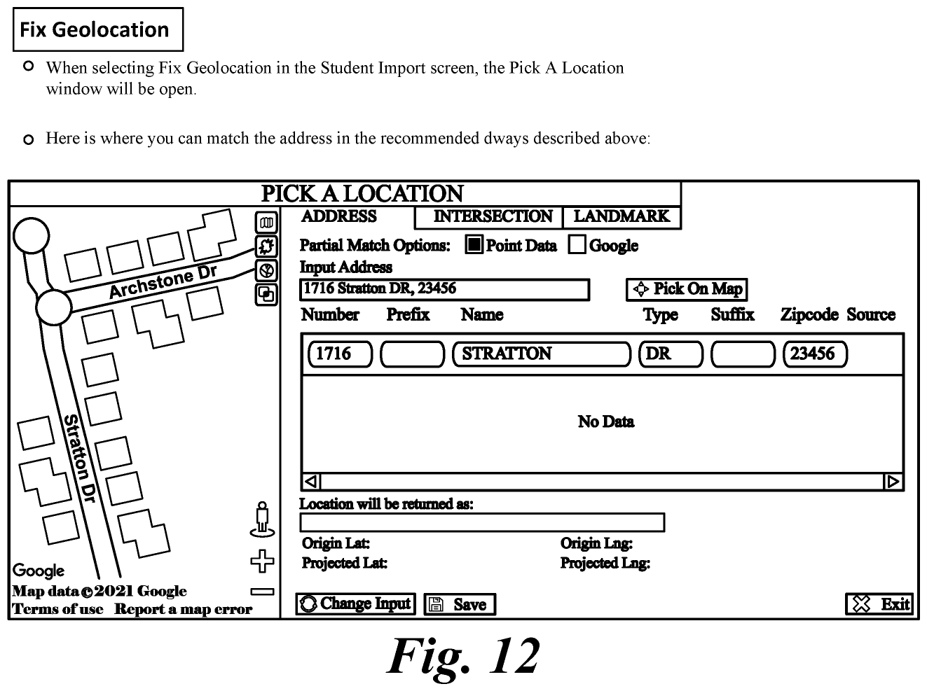

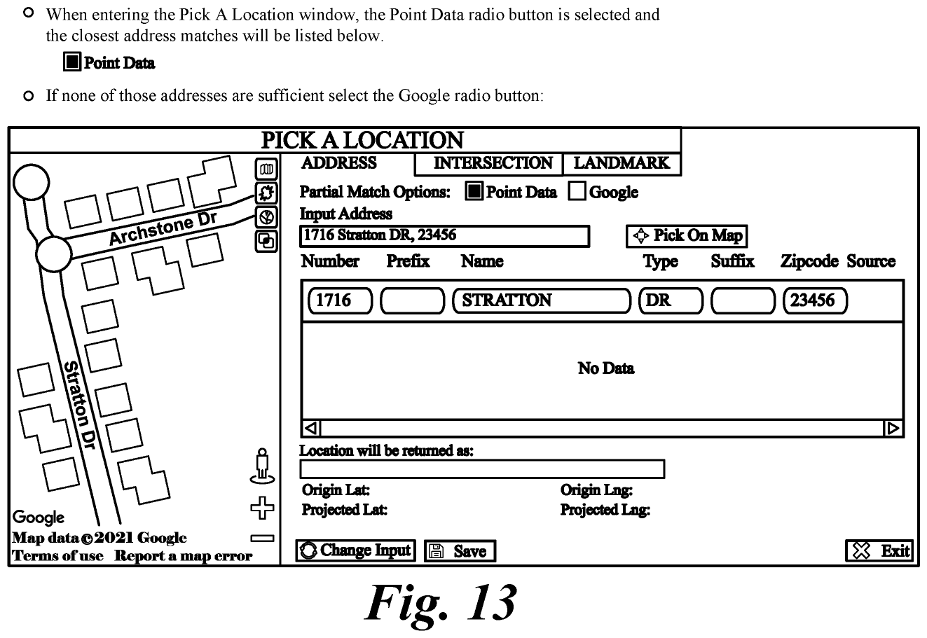

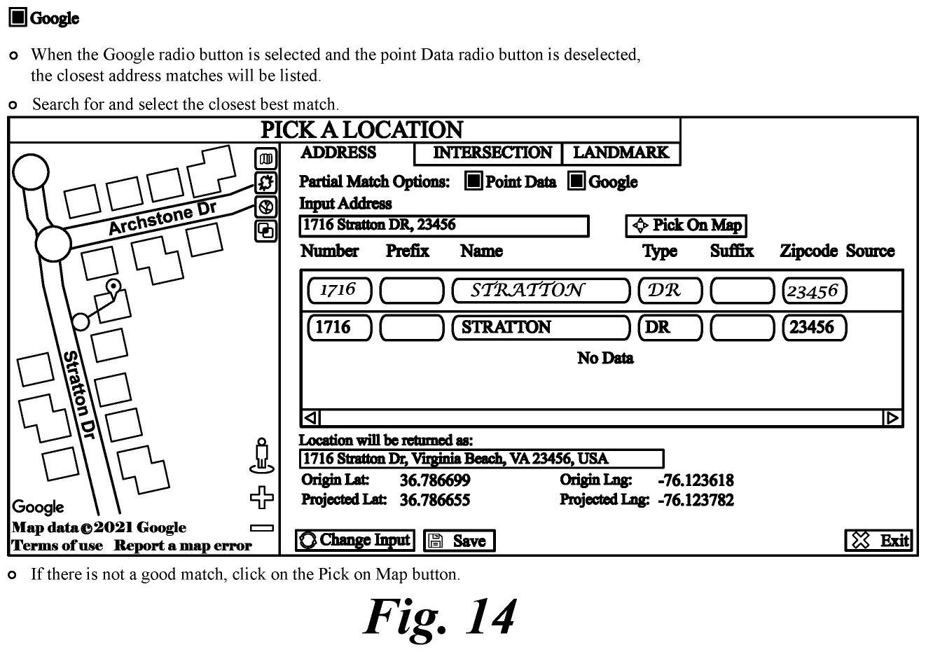

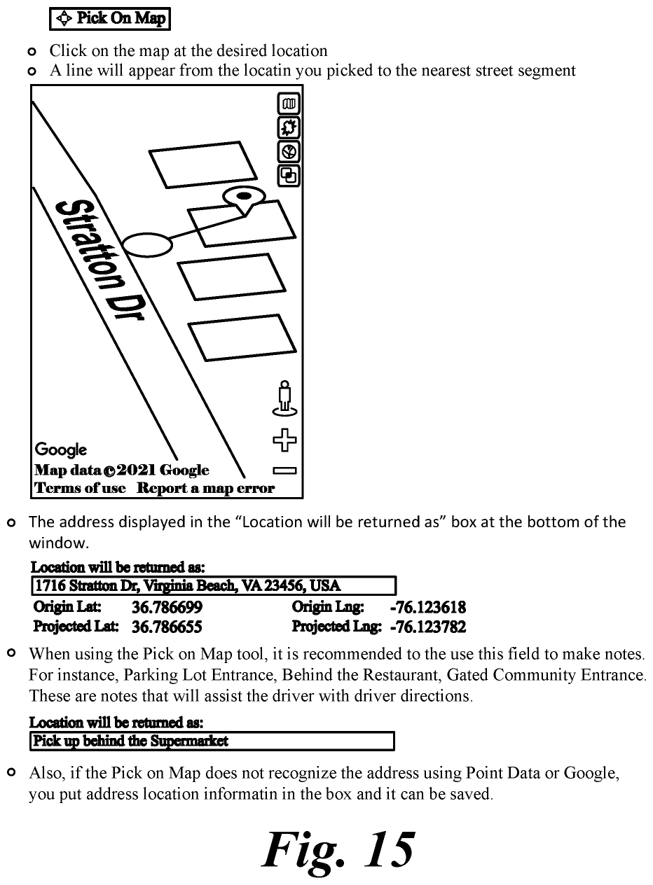

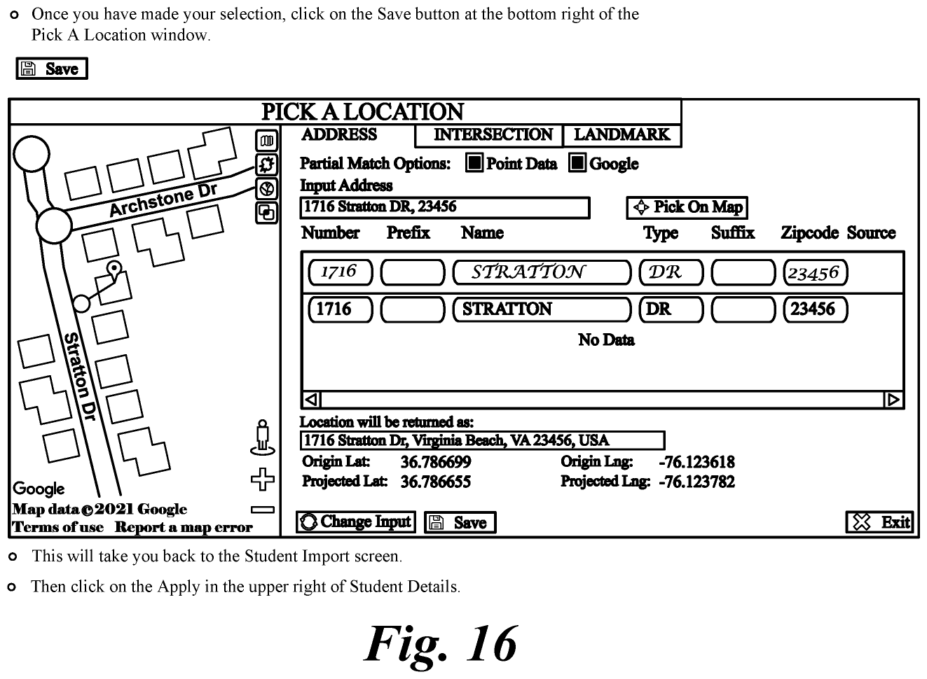

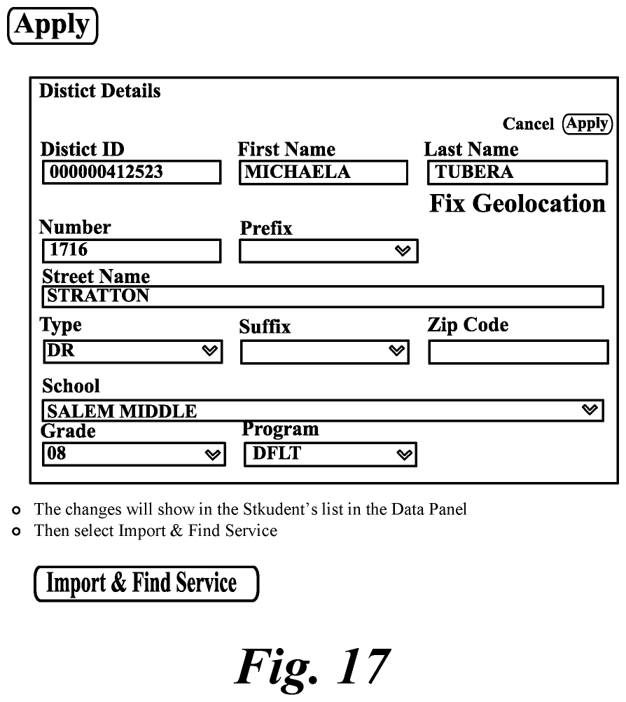

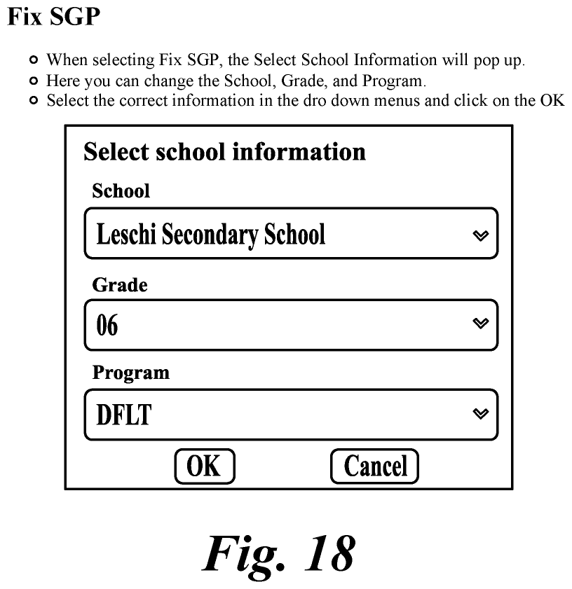

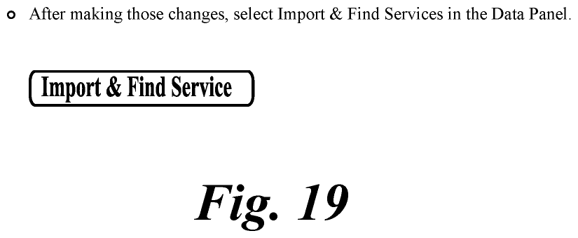

Referring to FIG. 10, the principle for intersection matching is the same as for address matching. For details refer to the specs for address matching, with the main differences for intersections being:

The input intersection is shown in street 1 & street 2. These fields are not editable (same behavior as with the address case). When the user clicks on one of them, the system will find a match for the corresponding street name.

The process starts with writing the parsed street name in the work row of the table and takes the user through the relevant steps in the address matching process to find the correct full street name.

After the user has validated the first street, the system should check for a unique match. If it is found, the task is completed. If not, the second street needs to be validated and then a new check for unique match. If at his point, there is no match still, the map can be used to check if:

The two streets meet at more than one place (in which case the user can simply point to the desired location).

The two streets do not meet. This error condition may require correction to the map center line.

In this last case, the user can select digitization and complete the task by picking the desired location on the map

FIG. 7 illustrates a process 700, according to an embodiment of the invention, for identifying student/rider locations in a scenario in which the route management system cannot otherwise do so to achieve the objectives of the invention discussed above herein. The process 700 is illustrated as a set of operations shown as discrete blocks. One or more steps of the process 700 may be implemented in any suitable hardware, software, including instructions embodied within components, firmware, or combination thereof and enabled by data calls to database 240 from one or more of client device 270, server 230 and computer system 260. The order in which the operations associated with the process 700 are described is not to be necessarily construed as a limitation.

At a step 701, a location data entry (address, intersection, landmark, etc.) associated with the student/rider cannot be matched/identified by the RMS such that the LP user interface 900 illustrated in FIGS. 9 and 10 is invoked. At a step 702, and using a street address as an example, a determination is made as to whether the LP module has found an exact match for the street name. If affirmative, then, at a step 703, it is determined that the street number is deficient, and the user is presented with multiple displayed options to assist with determining the correct number. At a step 704, the user is presented with the option to make a selection from the displayed options or correct the number in the work row 901. If negative, the user terminates the address-matching attempt at a step 706. Otherwise, at a step 705, the user is given the opportunity to match the new number with a number in the list until successfully completed.

If at step 702 the result is negative, then a determination is made at a step 707 as to whether there is an exact match for the name field in work row 901. If affirmative, then the UI 900 displays all full street names containing the name field at a step 708. At a step 709, the user selects one of the displayed street names. At a step 710, the LP system attempts to match the selected street name with the entries in the work row 901. At a step 711, a determination is made as to whether the match was successful. If negative, then the process proceeds to step 703. If affirmative, then, at a step 712, the process is completed for the input address.

If at step 707 the result is negative, then, at a step 713 the UI 900 displays a list of all names that begin with the current entry. At a step 714, the user selects one of the names. At a step 715, the system displays the name selection. At a step 716, the LP system attempts to match the selected street name with the entries in the work row 901. At a step 716, a determination is made as to whether the match was successful. If negative, then the process proceeds to step 718. If affirmative, then, at a step 717, the process is completed for the input address.

If at step 716 the result is negative, then at a step 718 the UI 900 displays a list of all names that exactly contain the current entry in the name field. At a step 719, the user selects one of the names. At a step 720, the system displays the name selection. At a step 720, the LP system attempts to match the selected street name with the entries in the work row 901. If affirmative, then the process is completed for input address at a step 722. Otherwise, the process proceeds to step 703.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims.

What is claimed is:

1. At least one computer-readable medium on which are stored instructions that, when executed by one or more processing devices, enable the one or more processing devices to perform a method, the method comprising the steps of:
receiving over a network a data set corresponding to a passenger seeking transportation to a destination, the data set including an address of origin of the passenger;
accessing a first database that includes a first set of geocodes that correspond to addresses within a particular geographic region of interest, the region of interest including the passenger address of origin;
determining if there is a geocode in the first database that corresponds to the passenger address of origin;
if there is not a geocode in the database that corresponds to the passenger address of origin, automatically creating a geocode that corresponds to the passenger address of origin; and
providing the created geocode to a route management system.

2. The medium of claim 1, wherein the method further comprises automatically designating the passenger for inclusion in a transportation route using the created geocode.

3. The medium of claim 1, wherein automatically creating a geocode that corresponds to the passenger address of origin comprises accessing a second database that includes a second set of geocodes that correspond to addresses within the particular geographic region of interest.

4. The medium of claim 1, wherein automatically creating a geocode that corresponds to the passenger address of origin comprises selecting with a pointer device a digital representation of the passenger address of origin on a digital map presented on a display device.
